(19) United States
(12) Patent Application Publication
(10) Pub. No.: US 2019/0289793 A1
(43) Pub. Date: Sep. 26, 2019

(54) TREE BRANCH SUPPORT APPARATUS AND METHOD

(71) Applicant: Majid Haghoo, Woodland Hills, CA (US)

(72) Inventor: Majid Haghoo, Woodland Hills, CA (US)

(21) Appl. No.: 15/935,374

(22) Filed: Mar. 26, 2018

(51) Int. Cl. A01G 9/12; A01G 22/05

(52) U.S. Cl. CPC A01G 9/122; A01G 22/05; A01G 9/126

(57) ABSTRACT

A method and apparatus for shaping and lifting a plurality of trees of varying heights and denseness using a cost-effective, universal tree shaping system. The apparatus comprises a sprocket having a central aperture and scalloped recesses around a perimeter. The sprocket is mounted to the top portion of a telescoping pole, which may have an implement at the bottom for securing in the ground. The pole is telescoped to lengthen the pole such that the top of the pole is approximately at the top of the tree. The sprocket is located on the top of the pole, providing a fulcrum for each of a plurality of cables. The plurality of cables (ropes, twine, or the like) are passed over the sprocket, where each cable is passed over two diametrically opposed scalloped recesses and secured to first and second tree branches.

### BACKGROUND

Fruit trees such as apple, pears, cherry, and citrus rely on sunshine to grow, dry, and warm the branches, leaves and fruit. It is imperative to maintain separation of the branches to ensure both aeration and adequate sunshine reaches the interior of the trees. It is often necessary to prune the trees heavily to ensure that the tree receives enough sunshine and adequate airflow to dry the trees, and to prevent the build-up of frost or ice. However, pruning can lower the yield of the tree and when done incorrectly, can damage the tree.

Training fruit trees starts is a process whereby the branches of the tree are placed into a desired position as the tree grows to ensure desirable characteristics. Its more efficient to train trees early by placing limbs in a position, rather than pruning them later. Growth in fruit trees is regulated by plant hormones. Cytokinins produced in the roots move up to the highest points in the tree to break dormancy. When the buds on the tips of limbs start to grow, auxin is produced, and moves down the limb through gravity, and inhibits the growth of lateral buds below the highest points, an occurrence known as apical dominance. The best way to overcome apical dominance is to train branches early to grow more horizontal and remove unwanted upright shoots. The key to producing a well-trained tree in the shortest amount of time is to follow a training program consistently.

Training can also open spaces in the tree canopy for sunlight to penetrate and support leaf photosynthesis and the production of carbohydrates and energy that drive the growth of roots, shoots and fruits. Without adequate sunlight penetration during the growing season, flower bud production can be reduced with detrimental effects on cropping in the future. Training can reduce branch crowding and enable better air circulation that reduces humidity and allows for better coverage of protectant products (e.g., pesticides). Further, branch angles between a vertical trunk and lateral shoots are stronger as they approach a 90 degree angle. Narrow branch angles are typically weak and they may break under the weight of developing fruit, so training can help to ensure better branch orientation for better yields.

It would be beneficial to have a device that could easily work with any type of tree and enable the grower to maintain, separate, and lift the fruit laden branches of the trees in a particular formation to promote health, better yield, and aesthetics of the trees.

### SUMMARY OF THE INVENTION

The present invention is a method and apparatus for shaping and lifting a plurality of trees of varying heights and denseness using a cost-effective, universal tree shaping system. The apparatus comprises a large sprocket of wood, aluminum, plastic, or other durable material having a central aperture and scalloped recesses around a perimeter. The sprocket is mounted to the top portion of a telescoping pole, which may have an implement at the bottom for securing in the ground. The telescoping pole is either secured tightly to the tree trunk, or alternatively can be hammered into the ground using the implement to facilitate this securement. The pole is then telescoped to lengthen the pole such that the top of the pole is approximately at the top of the tree. The sprocket is located on the top of the pole, providing a fulcrum for each of a plurality of cables. The plurality of cables (ropes, twine, or the like) are passed over the sprocket, where each cable is passed over two diametrically opposed scalloped recesses and secured to first and second tree branches. Each cable lifts two branches, and can be cut to ensure that each branch is raised to the desired height. Attachment means can also be included on the ends of the cable, such as a collar, slip knot, sleeve, et cet. The tree can then be shaped in pairs of branches, which each scalloped recess and the sprocket occupying one or more cables.

These and other features of the present invention may best be understood with reference to the detailed description of the invention below along with the accompanying drawings.

### BRIEF DESCRIPTION OF THE DRAWINGS

FIG. 1 is a plan view of a first embodiment of a sprocket;

FIG. 2 is a side view, partially in cross-section, of the sprocket and telescoping pole;

FIG. 3 is a plan view of a plurality of cables

FIG. 4 is an illustration of a user attaching a first end of a cable to a tree branch;

FIG. 5 is an illustration of a user draping the cable over the sprocket; and

FIG. 6 is a fully implemented set of cables lifting a plurality of tree branches.

### DETAILED DESCRIPTION OF THE PREFERRED EMBODIMENTS

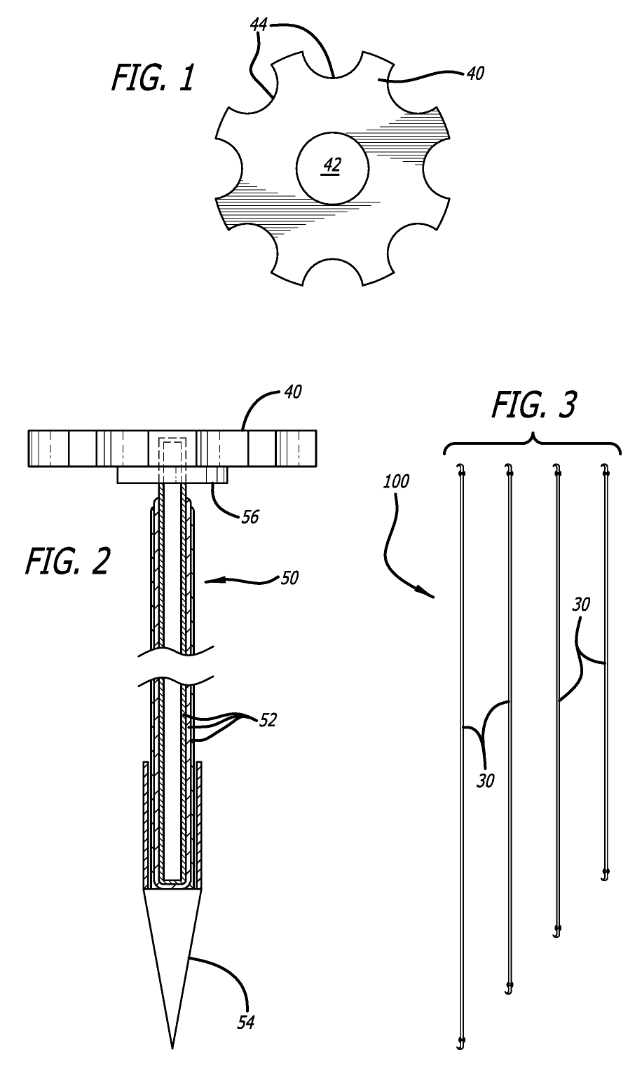

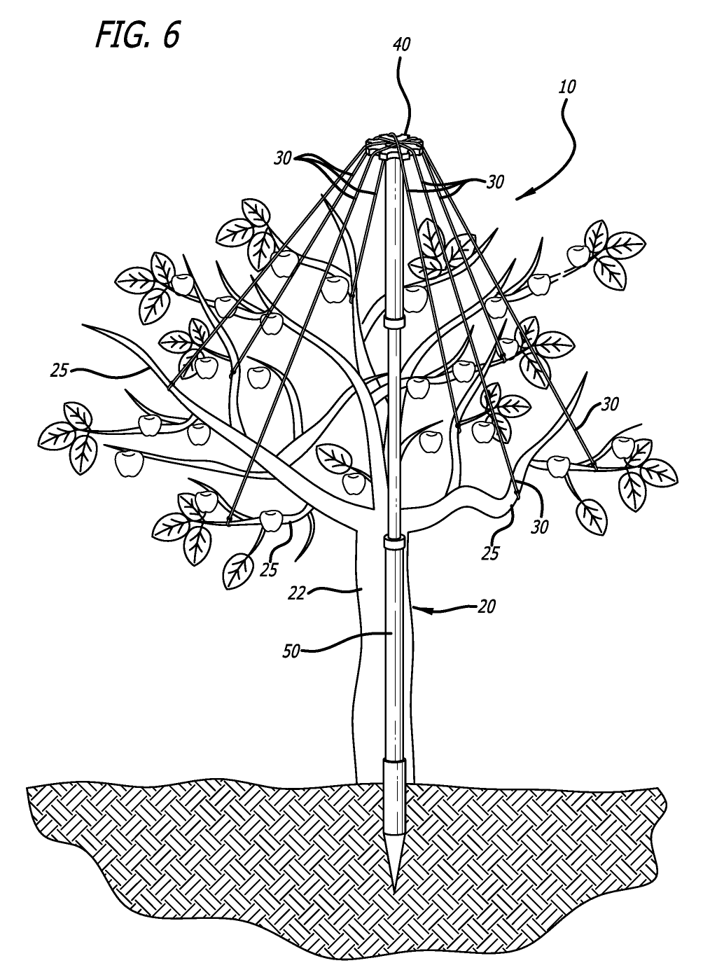

An apparatus 10 for lifting and separating branches of a tree 20, such as a fruit tree, is illustrated in FIG. 6. The tree 20 is comprised of a plurality of fruit bearing branches 25 which are held substantially horizontal by cables 30 (FIG. 3). Each end of the cables 30 are attached, tied, or otherwise connected to the branches 25 so that each cable 30 is connected to, and lifts two separate branches 25 of the tree 20. The cables 30 each pass over a sprocket 40 (FIG. 1) made of wood, aluminum, plastic, or other durable material. The sprocket 40 has a central aperture 42 and a plurality of scalloped outer recesses 44, the aperture for receiving a vertically mounted pole 50 and the scalloped outer recesses 44 for receiving the cables 30. The pole 50 (FIG. 2) has several nested cylindrical elements 52 that permit the pole 50 to telescope to adjustable lengths, and a conical lower end 54 is useful for inserting the pole into the ground at the base of the tree. Alternatively, the pole 50 can be attached to the tree trunk 22 using a belt, bracket, or other attachment devices. A washer is fixed, as by a threaded connection or other fixing means, to secure the sprocket 40 on the top of the vertical pole 50 as shown in FIG. 2.

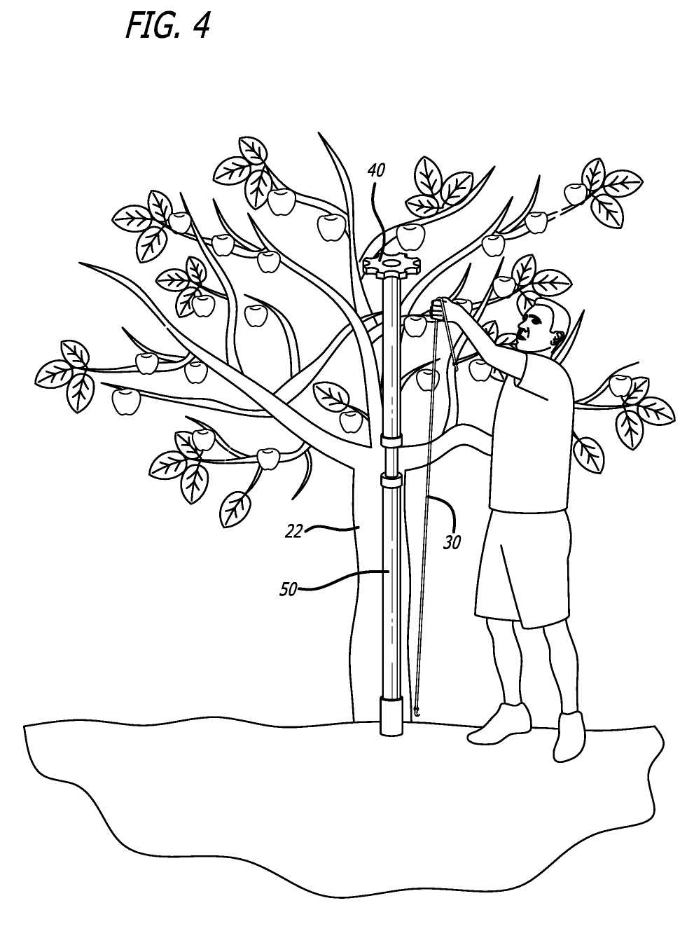

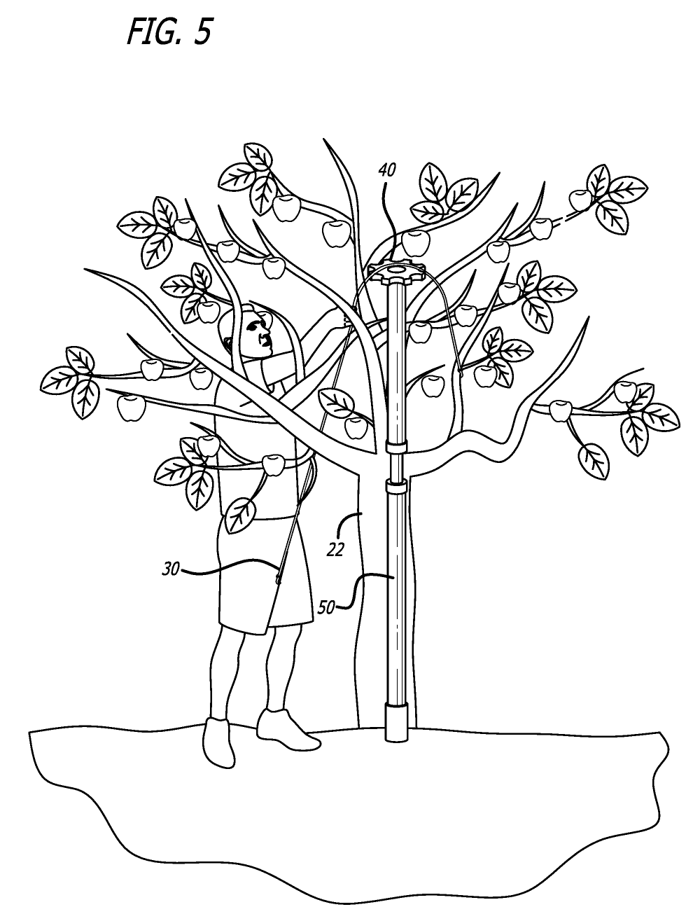

Turning to FIGS. 4-6, a method for suspending the tree branches using the just-described system is illustrated. The pole 50 is extending to a height at the top of the tree 20, such that the sprocket 40 is above all of the branches 25 to be lifted and the elevation to which the branches are to be lifted. The pole 50 is inserted into the ground, and a first cable 30 is attached to a first branch 25 as by tying or other connection means. The cable is then passed or draped over the sprocket (FIG. 5) so that the cable occupies two diametrically opposed scallop shaped recesses in the perimeter of the sprocket. The non-attached end of the cable 30 is then attached to a second branch 25 on the opposite side of the tree 20, but the length of the cable is adjusted to ensure that the suspension of both branches 25 meet the desired elevation, i.e., substantially horizontal. It should be noted that other angles are possible and even desirable for other trees and situations. The process is repeated with additional cables 30 (FIG. 6) until all of the branches 25 are lifted in the desired arrangement.

The method and apparatus described above, and the drawings associated therewith, are not intended to be limiting but rather illustrative. It is understood that a person of ordinary skill in the art would readily recognize and appreciate many modifications and substitutions to the foregoing descriptions and depictions, and the scope of the invention is intended to include all such modifications and descriptions. Nothing in the drawings or descriptions should be interpreted as exclusive or limiting unless expressly stated.

I claim:

1. A method for suspending a plurality of tree branches of a tree from a central pivot, comprising:
providing a vertical pole extending to a top of the tree;
attaching a sprocket to a top of the pole, the sprocket including scalloped recesses;
draping a plurality of cables over the sprocket, each cable having first and second ends, each end attached to a respective tree branch;
whereby a length of each cable is selected to raise the respective tree branches to a substantially horizontal position.

2. The method for suspending a plurality of tree branches of claim 1, wherein the vertical pole is telescoping.

3. The method for suspending a plurality of tree branches of claim 1, wherein a lower end of the vertical pole is narrowed to facilitate insertion into a ground.

4. The method for suspending a plurality of tree branches of claim 1, wherein each cable is draped over scalloped recesses that are one hundred eighty degrees apart on the sprocket.

5. The method for suspending a plurality of tree branches of claim 1, wherein the sprocket is mounted to the vertical pole using a washer.

6. A system for suspending a plurality of tree branches of a tree from a central pivot, comprising:
a sprocket having a plurality of scalloped recesses along an outer perimeter, and a central aperture;
a telescoping pole having a conical first end adapted to be inserted into a ground, and a stop mounted at a second end, the stop supporting the sprocket thereon to axially fix the sprocket at the first end of the telescoping pole; and
a plurality of cables adapted to pass over the sprocket within the scalloped recess and attach at respective ends to the tree branches.
